(19) United States
(12) Patent Application Publication
(10) Pub. No.: US 2004/0253456 A1
(43) Pub. Date: Dec. 16, 2004

(54) Solar shading louvre

(75) Inventor: Peter Braybrook, Gloucester (GB)

Correspondence Address: YOUNG & THOMPSON, 745 SOUTH 23RD STREET, 2ND FLOOR, ARLINGTON, VA, 22202, US

(73) Assignee: LEVOLUX A.T. LIMITED, GLOUCESTER (GB)

(21) Appl. No.: 10/671,828

(22) Filed: Sep. 29, 2003

(30) Foreign Application Priority Data
Jun. 10, 2003 (GB) 0313285.9

(51) Int. Cl. B32B 17/10

(52) U.S. Cl. 428/441; 428/515

(57) ABSTRACT

A solar shading louvre comprises two spaced light transmissible sheets, a light transmissible redirecting layer positioned between the light transmissible sheets, and a cured cold pour resin by which the light transmissible redirecting layer is fixed relative to the light transmissible sheets. The cold pour resin includes an inhibitor that prevents or inhibits an adverse reaction between the cold pour resin and the light transmissible redirecting layer. Solar shading incorporating the louvre and a method are also provided.

### INTRODUCTION

This invention relates to a solar shading louvre, a method of forming such a louvre, and to solar shading incorporating the louvre.

Energy conservation is a specific criteria for buildings. Sources of wasted energy come from controlling solar gain within a building, for example via air conditioning units, and also from the extensive use of interior electrical lighting.

It has been suggested in British patent application number 0203817.2 to use solar shading on the exterior of a building to control the solar gain within the building and to supplement or replace the interior electrical lighting requirements.

However, the formation of solar shading louvers has been problematic and limiting in their usefulness. It is present practice to cover the two major surfaces of a light transmissible redirecting layer with a layer of PVB, and then sandwich this between two uniform glass sheets. The edges of the louvre are sealed against moisture using a continuous opaque external sealing strip, and the louvre is then heated to melt the PVB and bond the light transmissible redirecting layer to the glass sheets.

The quality of glass must be high and the surfaces smooth and uniform to enable adequate bonding of the PVB thereto, thus preventing, for example, toughened glass being used; and the fact that the edges of the resulting louvre are covered by an opaque layer (normally a mechanical trim) to prevent moisture ingress limits use in modem architectural design.

The present invention seeks to provide a solution to these problems.

### SUMMARY OF THE INVENTION

According to a first aspect of the present invention, there is provided a solar shading louvre comprising two spaced light transmissible sheets, a light transmissible redirecting layer positioned between the light transmissible sheets, and a cured cold pour resin by which the light transmissible redirecting layer is fixed relative to the light transmissible sheets, the cold pour resin including an inhibitor that prevents or inhibits an adverse reaction between the cold pour resin and the light transmissible redirecting layer.

According to a second aspect of the present invention, there is provided solar shading having a plurality of louvers as claimed in any one of the preceding claims.

According to a third aspect of the present invention, there is provided a method of forming a solar shading louvre, comprising the steps of:

a) positioning a light transmissible redirecting layer in a cavity between two light transmissible sheets;

b) injecting a cold pour resin having an inhibitor into the cavity to seal the light transmissible redirecting layer between the two light transmissible sheets,

wherein the inhibitor of the cold pour resin prevents or inhibits an adverse reaction between the cold pour resin and the light transmissible redirecting layer.

The invention will now be described, by way of example, with reference to the accompanying drawings.

### BRIEF DESCRIPTION OF THE DRAWINGS

FIG. 1 shows part of one embodiment of a solar shading louvre with an upper light transmissible sheet omitted for clarity and in accordance with the first aspect of the invention; and

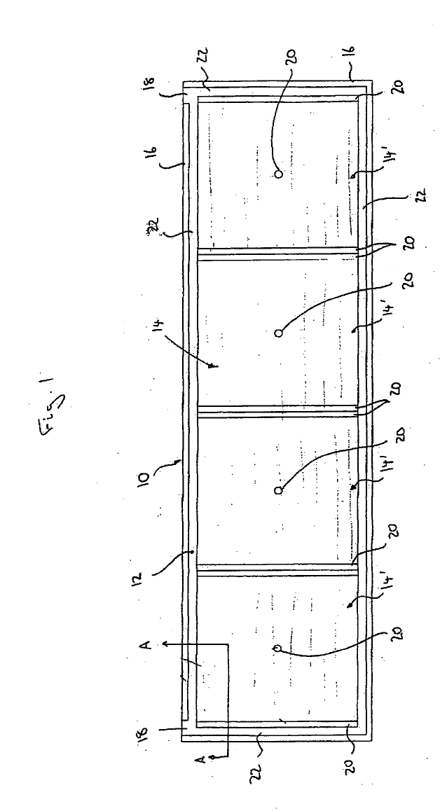

FIG. 2 is a sectional view along the line A-A in FIG. 1.

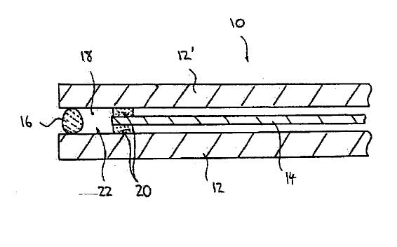

### DESCRIPTION OF THE PREFERRED EMBODIMENTS

Referring to the drawings, there is shown part of a solar shading louvre 10 which comprises a first light transmissible sheet 12, typically in the form of a sheet of glass, and a light transmissible redirecting layer 14 positioned on the light transmissible sheet 12.

The light transmissible redirecting layer 14 is typically a transparent or substantially transparent plastics layer with a light redirecting characteristic. Such material may be Degussa Plexiglas zk6HT moulding compound, and one common example goes under the trade name of SerraGlaze^{RTM}. A typical thickness of the light transmissible redirecting layer 14 is about 1 millimetre (mm).

The peripheral edge of the first light transmissible sheet 12 is lined with a known transparent laminating silicon bead 16. The bead 16 is around 3 mm thick. The bead 16 includes two breaks or gaps 18, reasons for which will become apparent hereinafter.

The light transmissible redirecting layer 14, such as SerraGlaze^{RTM}, commonly includes a multitude of minute parallel extending capillaries (not shown) to generate the light redirecting characteristic. These capillaries tend to trap moisture, which may cause problems when sealed in a louvre 10. Prior to installation on the light transmissible sheet 12, the light transmissible redirecting layer 14 is heated to drive out moisture within the capillaries, and then the edges of the layer having the openings to the capillaries are high frequency sealed. Moisture is thus prevented from being absorbed or discharged.

Although not shown, the high frequency sealing is improved by pressing a row of castellations along the edge, simultaneously with the welding. The castellations act to increase the available surface area over which the sealing can take place.

A single continuous sheet of the light transmissible redirecting material can be used, or alternatively, as shown in the FIG., a plurality of smaller sheets 14′ can be used placed side-by-side. In either case, the light transmissible redirecting layer 14 is held in position to one surface of the light transmissible sheet 12 using strips of transparent tape 20 along opposing edges on one major surface. The transparent tape 20 has a thickness of about 1 mm.

Matching strips of transparent tape 20 are also positioned on the opposing edges of the other major surface of the light transmissible redirecting layer 14, to enable bonding to a second light transmissible sheet 12′.

A further small portion of tape 20 may be provided at, or adjacent to, the centre of the light transmissible redirecting layer 14 to further inhibit undesirable displacement of the layer 14 relative to the light transmissible sheet 12.

A border 22 extends between the perimeter of the light transmissible redirecting layer 14 and the perimeter of the light transmissible sheet 12.

The second light transmissible sheet 12′ matches the first light transmissible sheet 12 and is placed on the laminating bead 16. The light transmissible redirecting layer 14 is thus sandwiched between the first and second light transmissible sheets 20 and 12′.

Due to the thickness of the laminating bead 16 and the matching total thickness of the light transmissible redirecting layer 14 and transparent tape 20, a narrow cavity in which the light transmissible redirecting layer 14 is supported is formed between the opposing surfaces of the first and second light transmissible sheets 12 and 12′.

A cold pour resin (not shown) is fed or injected into the cavity between the two light transmissible sheets 12 and 12′ using the two aforementioned breaks or gaps 18 in the laminating bead 16.

The cold pour resin is a solution of thermosetting resin and styrene. One such example of this type of cold pour resin is Uniguar^{RTM} 518 resin. However, other types of cold pour resin may be useable.

The cold pour resin includes a priming agent for assisting bonding of the cold pour resin to the light transmissible sheets, a curing agent to accelerate curing of the resin, and an inhibitor to prevent or inhibit an adverse reaction between the resin and the light transmissible redirecting layer 14.

Typically, the priming agent is gamma-methacryloxypropyltrimethoxysilane; the curing agent is methylethylketoneperoxide; and the inhibitor is a solution of vinyltrimethoxysilane, methanol and ethyltrimethoxysilane. However, any suitable priming agent, curing agent and inhibitor could be used.

The breaks or gaps 18 in the laminating bead 16 are then blocked using a suitable clear sealant (not shown). This prevents ingress of particulate matter and moisture, and leakage of the cold pour resin prior to curing. Once cured, the light transmissible redirecting layer 14 is encapsulated in, and the two light transmissible sheets 12,12′ are bonded together by, the cold pour resin.

The light transmissible sheets may also include a body tint (not shown) formed as part thereof. The body tint enables control of solar gain, since it reflects a portion of incident light while absorbing a portion of incident heat energy. Control of solar gain and interior lighting within a building, as described in GB 0203817.2, can thus be realised when using exterior mounted solar shading which incorporates the above-described louvre 10.

The louvre may, alternatively or additionally, include other types of coatings to enable control of solar gain, such as a pyrolitic coating or a Low-E coating formed on a surface of the louvre.

The louvre of the present invention can be used as part of solar shading, and may be angularly adjustable or fixed.

The use of cold pour resin is especially advantageous in that different types and qualities of light transmissible sheets can be used. For example, toughened glass can be used to sandwich the light transmissible redirecting layer, which has not been possible when using the known PVB-layer method due to the irregular non-uniform surface of toughened glass and the inherent inability of PVB to flow, thus preventing reliable bonding.

A perimeter sealing strip around the exterior edge of the louvre, to act as a moisture barrier, is no longer necessary when using cold pour resin. As a consequence, the louvre has a higher light transmissibility, especially through its edges. This characteristic is especially advantageous in modern architectural design.

The light transmissible sheets could be plastics material, instead of glass.

One, or more than two breaks or gaps 18 may be provided.

It is thus possible to provide a solar shading louvre which encapsulates a light transmissible redirecting layer without the need for a perimeter sealing strip around the exterior edge of the louvre. It is also possible to provide a solar shading louvre which has a light transmissible redirecting layer and which utilises a cold pour resin to hold the redirecting layer stationary relative to the rest of the louvre while preventing any undesirable reaction between the layer and the resin. It is further possible to provide a solar shading louvre which can be formed from a variety of light transmissible materials, and which is also light transmissible from any viewing direction.

The embodiments described above are given by way of examples only, and other modifications will be apparent to persons skilled in the art without departing from the scope of the invention as defined by the appended claims.

What is claimed is:

1. A solar shading louvre comprising two spaced light transmissible sheets, a light transmissible redirecting layer positioned between the light transmissible sheets, and a cured cold pour resin by which the light transmissible redirecting layer is fixed relative to the light transmissible sheets, the cold pour resin including an inhibitor that prevents or inhibits an adverse reaction between the cold pour resin and the light transmissible redirecting layer.

2. A louvre as claimed in claim 1, wherein the cold pour resin is a solution of thermosetting resin and styrene.

3. A louvre as claimed in claim 2, wherein the cold pour resin is Uniguard ^{RTM} 0518 resin.

4. A louvre as claimed in claim 1, wherein the cold pour resin includes a priming agent for assisting bonding of the cold pour resin to the light transmissible sheets.

5. A louvre as claimed in claim 4, wherein the priming agent is gamma-methacryloxypropyltrimethoxysilane.

6. A louvre as claimed in claim 1, wherein the cold pour resin includes a curing agent.

7. A louvre as claimed in claim 6, wherein the curing agent is methytethylketoneperoxide.

8. A louvre as claimed in claim 1, wherein the inhibitor is a solution of vinyttrimethoxysitane, methanol and ethyltrimethoxysilane.

9. A louvre as claimed in claim 1, wherein the light transmissible sheets are glass.

10. A louvre as claimed in claim 9, wherein the glass is toughened glass.

11. A louvre as claimed in claim 1, further comprising solar control by which reflectivity of incident light and solar gain can be controlled.

12. A louvre as claimed in claim 11, wherein the solar control is in the form of a body tint formed as part of each light transmissible sheet, the body tint reflecting a portion of incident light and absorbing a portion of incident heat energy.

13. A louvre as claimed in claim 1, wherein the light transmissible redirecting layer is Serraglaze^{RTM}.

14. A louvre as claimed in claim 1, wherein the edges of the light transmissible redirecting layer are sealed to prevent moisture absorption and/or discharge.

15. Solar shading having a plurality of louvres each comprising two spaced light transmissible sheets, a light transmissible redirecting layer positioned between the light transmissible sheets, and a cured cold pour resin by which the light transmissible redirecting layer is fixed relative to the light transmissible sheets, the cold pour resin including an inhibitor that prevents or inhibits an adverse reaction between the cold pour resin and the light transmissible redirecting layer.

16. Solar shading as claimed in claim 15, wherein the louvers are angularly displaceable.

17. Solar shading as claimed in claim 15, wherein the louvers are fixed.

18. Solar shading as claimed in claim 15, wherein the solar shading is mounted on the exterior of a building.

19. A method of forming a solar shading louvre, comprising the steps of:
a) positioning a light transmissible redirecting layer in a cavity between two light transmissible sheets;
b) injecting a cold pour resin having an inhibitor into the cavity to seal the light transmissible redirecting layer between the two light transmissible sheets,
wherein the inhibitor prevents or inhibits an adverse reaction between the cold pour resin and the light transmissible redirecting layer.

20. A method as claimed in claim 19, further comprising a step (c) prior to step (a) of creating a peripheral seal between the light transmissible sheets, the peripheral seal including at least one pour opening.

21. A method as claimed in claim 20, further comprising a step (d) subsequent to the step (b) of sealing the or each pour opening.

22. A method as claimed in claim 19, wherein the cold pour resin also includes a curing agent to accelerate curing and a priming agent to assist bonding to the light transmissible sheets.

23. A method as claimed in claim 19, further comprising a step (e) prior to step (a) of heating and sealing the edges of the light transmissible redirecting layer.

24. A method as claimed in claim 19, wherein the inhibitor is a solution of vinyltrimethoxysilane, methanol and ethyltrimethoxysilane.
